(19) United States
(12) Patent Application Publication
(10) Pub. No.: US 2026/0342193 A1
(43) Pub. Date: Oct. 29, 2026

(54) VIBRATION MOTOR

(71) Applicant: AAC Microtech (Changzhou) Co., Ltd., Changzhou City (CN)

(72) Inventors: Xixi Zou, Changzhou (CN); Hongmei Yan, Changzhou (CN); Xia Zheng, Changzhou (CN)

(21) Appl. No.: 19/342,698

(22) Filed: Sep. 29, 2025

Related U.S. Application Data
(63) Continuation of application No. PCT/CN2025/090583, filed on Apr. 23, 2025.

(51) Int. Cl. H02K 33/18

(52) U.S. Cl. CPC H02K 33/18

(57) ABSTRACT

A vibration motor is provided according to the present disclosure, which includes a cover plate, a coil winding and a flexible circuit board fixed to a side of the cover plate, a magnet assembly with a magnetic gap and arranged opposite to and spaced apart from the cover plate, and an elastic member fixed to the cover plate and the magnet assembly. The coil winding is inserted and suspended in the magnetic gap, and the coil winding and the flexible circuit board form an electrical connection. The magnet assembly is arranged opposite to the cover plate, and the elastic member elastically suspends the magnet assembly on the cover plate.

### CROSS REFERENCE TO RELATED APPLICATIONS

The present application is a continuation of PCT Patent Application No. PCT/CN2025/090583, filed Apr. 23, 2025, which is incorporated by reference herein in its entirety.

### TECHNICAL FIELD

The present disclosure relates to the technical field of vibration, and in particular to a vibration motor.

### BACKGROUND

An X-axis linear motor is a machine that converts other forms of energy into mechanical vibration, mainly to provide realistic vibration feedback for users during touch operations, such as on a tablet touchscreen, an automotive touchscreen, and a laptop touchscreen with vibration sensation.

The X-axis linear motor in the related technology mainly includes a housing, a rotor, a stator, an amplifier, and a flexible circuit board with a control system.

Although the X-axis linear motor can provide realistic vibration feedback during touch operations, it is bulky, complicated in structure, cumbersome in assembly, and high in cost, so it is- unsuitable for small-volume and low-cost devices.

Therefore, it is necessary to provide a new vibration motor to address the above technical problems.

### SUMMARY

An object of the present disclosure is to provide a novel vibration motor, so as to solve the problem that the X-axis linear motor is unsuitable for small-volume and low-cost devices.

In a first aspect, a vibration motor is provided according to the present disclosure, which includes a cover plate, a coil winding fixed to a side of the cover plate, a magnet assembly with a magnetic gap and arranged opposite to and spaced apart from the cover plate, and an elastic member elastically connecting the magnet assembly to the cover plate, wherein the coil winding is inserted and suspended in the magnetic gap.

The cover plate and the coil winding serve as one of a rotor and a stator of the vibration motor, the magnet assembly serves as the other of the rotor and the stator of the vibration motor, and the stator is configured to drive the rotor to vibrate.

As an improvement, the magnet assembly includes a lower clamping plate arranged opposite to and spaced apart from the cover plate, a main magnet stacked and fixed to a side of the lower clamping plate close to the cover plate, and an auxiliary magnet arranged around the main magnet and spaced apart from the main magnet to form the magnetic gap, and the auxiliary magnet is stacked and fixed to the lower clamping plate.

As an improvement, the magnet assembly further includes a pole core stacked and fixed to a side of the main magnet close to the cover plate.

As an improvement, the elastic member, the lower clamping plate, the main magnet, the auxiliary magnet and the pole core are coaxially arranged.

As an improvement, the cover plate includes a main body portion, a bent portion formed by bending and extending an edge of the main body portion toward a side of the magnet assembly, a fixing portion formed by protruding and extending an edge of the main body portion outward, a through hole extending through a central region of the main body portion, and an elongated extending hole sequentially extending through the main body portion, the bent portion, and the fixing portion, and the extending hole is in communication with the through hole. The vibration motor further includes a flexible circuit board fixed to a side of the fixing portion close to the magnet assembly, the coil winding is arranged around the through hole and fixed to a side of the main body portion close to the magnet assembly, and two ends of the coil winding extend from the extending hole to the flexible circuit board and form a fixed electrical connection with the flexible circuit board.

As an improvement, the elastic member includes a first fixed arm fixed to a side of the bent portion close to the magnet assembly, a second fixed arm fixed to a side of the magnet assembly close to the cover plate, and an elastic arm connecting the first fixed arm with the second fixed arm.

As an improvement, the coil winding is annular, the main magnet is circular, and the auxiliary magnet is annular.

As an improvement, the coil winding is rectangular annular, the main magnet is rectangular, and the auxiliary magnet is rectangular annular.

As an improvement, the magnet assembly has at least two magnetic gaps distributed from inside to outside, a number of coil windings is the same as a number of the at least two magnetic gaps, and each respective coil winding of the coil windings is inserted and suspended in a respective magnetic gap of the at least two magnetic gaps.

As an improvement, the magnet assembly includes a lower clamping plate arranged opposite to and spaced apart from the cover plate, a main magnet stacked and fixed to a side of the lower clamping plate close to the cover plate, an auxiliary magnet arranged around the main magnet and spaced apart from the main magnet, and a first auxiliary magnet arranged around the auxiliary magnet and spaced apart from the auxiliary magnet. The auxiliary magnet and the first auxiliary magnet are stacked and fixed to the lower clamping plate, the auxiliary magnet and the main magnet are spaced apart to form a first magnetic gap, the first auxiliary magnet and the auxiliary magnet are spaced apart to form a second magnetic gap, and two coil windings are respectively inserted into the two magnetic gaps.

Compared with the related technology, the vibration motor according to the present disclosure can form a direct-drive ultra-thin motor by arranging the cover plate, the coil winding fixed to the cover plate, the magnet assembly with the magnetic gap and arranged opposite to and spaced apart from the cover plate, and the elastic member elastically connecting the magnet assembly to the cover plate, and the vibration motor has the advantages of fast response, strong vibration sensation, simple structure, convenient assembly, reduced production requirements and production costs, and is suitable for small-volume and low-cost devices.

### BRIEF DESCRIPTION OF THE DRAWINGS

In order to explain the technical solution of the present disclosure more clearly, a brief description will be given to the accompanying drawings required for the description of the embodiments. Obviously, the drawings in the following description are only some embodiments of the present disclosure, and other drawings can be obtained according to these drawings without creative efforts.

FIG. 1 is a schematic perspective view of a first vibration motor provided by an embodiment of the present disclosure.

FIG. 2 is a schematic exploded view of a partial structure of the first vibration motor provided by an embodiment of the present disclosure.

FIG. 3 is a cross-sectional view taken along line A-A in FIG. 1.

FIG. 4 is a schematic diagram showing a state where a cover plate and a coil winding serve as a stator in the first vibration motor provided by an embodiment of the present disclosure.

FIG. 5 is a schematic diagram showing a state where a cover plate and a coil winding serve as a rotor in the first vibration motor provided by an embodiment of the present disclosure.

FIG. 6 is a schematic diagram of a magnet assembly in the first vibration motor provided by an embodiment of the present disclosure.

FIG. 7 is a layout diagram of a coil winding and a magnet assembly in a second vibration motor provided by an embodiment of the present disclosure.

FIG. 8 is a layout diagram of coil windings and a magnet assembly in a third vibration motor provided by an embodiment of the present disclosure.

### REFERENCE NUMERALS ARE LISTED AS FOLLOWS

100, vibration motor; 1, cover plate;

11, main body portion; 12, bent portion;

13, fixing portion; 14, through hole;

15 extending hole; 2, coil winding;

3, flexible circuit board; 4, magnet assembly;

41, lower clamping plate; 42, main magnet;

43, auxiliary magnet; 44, pole core;

45, first auxiliary magnet; 5, elastic member;

51, first fixed arm; 52, second fixed arm;

53, elastic arm; 10, magnetic gap.

### DETAILED DESCRIPTION OF THE EMBODIMENTS

In the following, the technical solution in the present disclosure will be clearly and completely described with reference to the attached drawings. Obviously, the described embodiment is only a part of the embodiments of the present disclosure, not all the embodiments. Based on the embodiments in the present disclosure, all other embodiments obtained by those skilled in the art without creative efforts fall within the protection scope of the present disclosure.

### FIRST EMBODIMENT

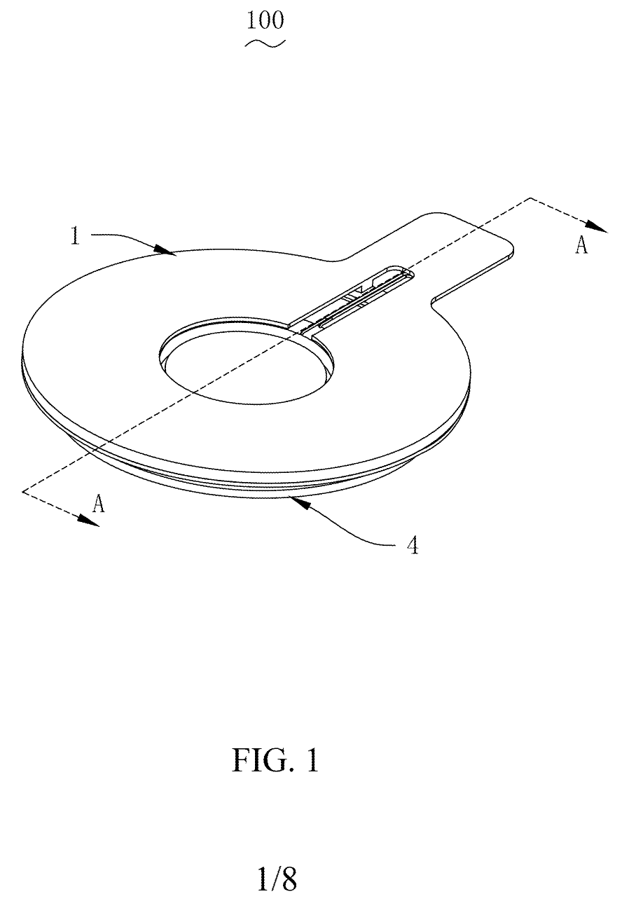

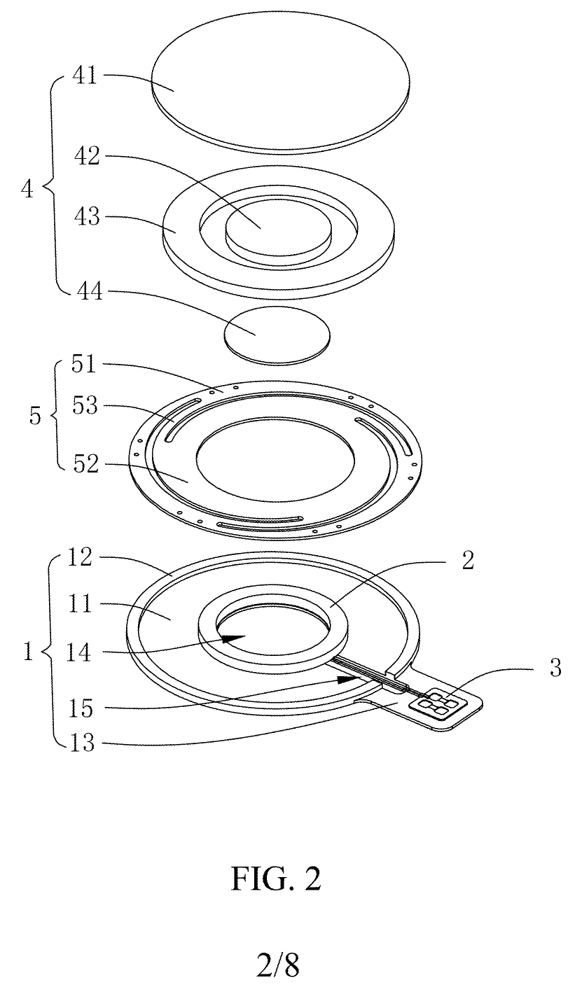

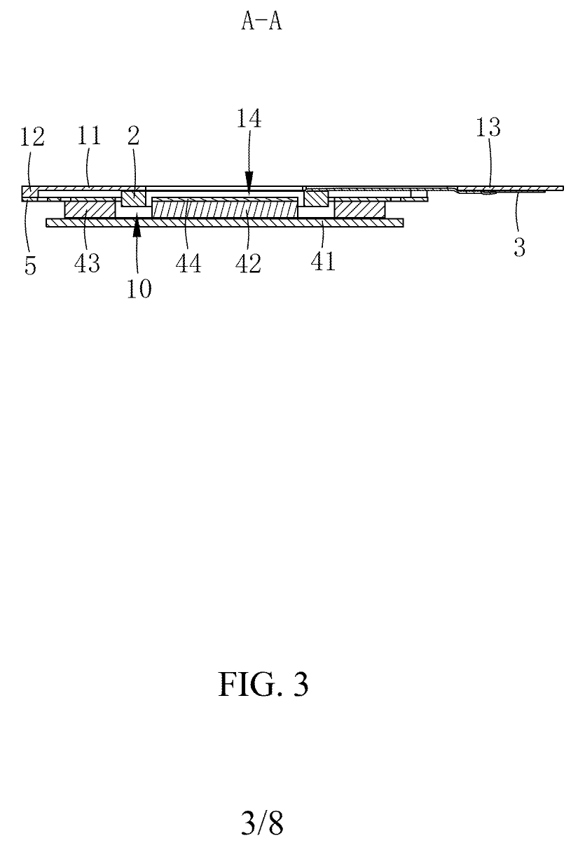

A vibration motor 100 is provided according to an embodiment of the present disclosure, as shown in FIGS. 1 to 3, which includes a cover plate 1, a coil winding 2 fixed to a side of the cover plate 1, a magnet assembly 4 with a magnetic gap 10 and arranged opposite to and spaced apart from the cover plate 1, and an elastic member 5 elastically connecting the magnet assembly 4 to the cover plate 1, and the coil winding 2 is inserted and suspended in the magnetic gap 10.

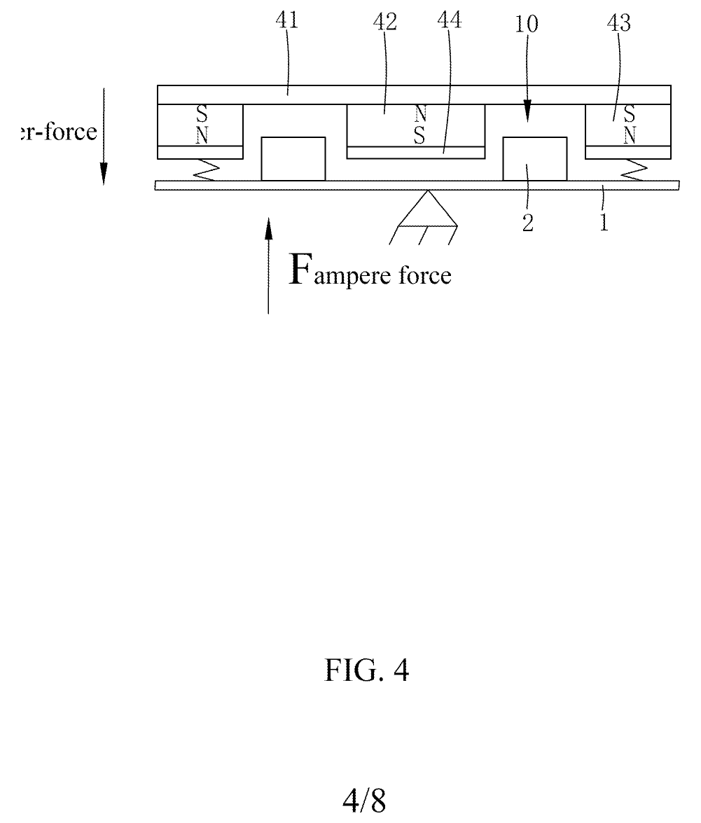

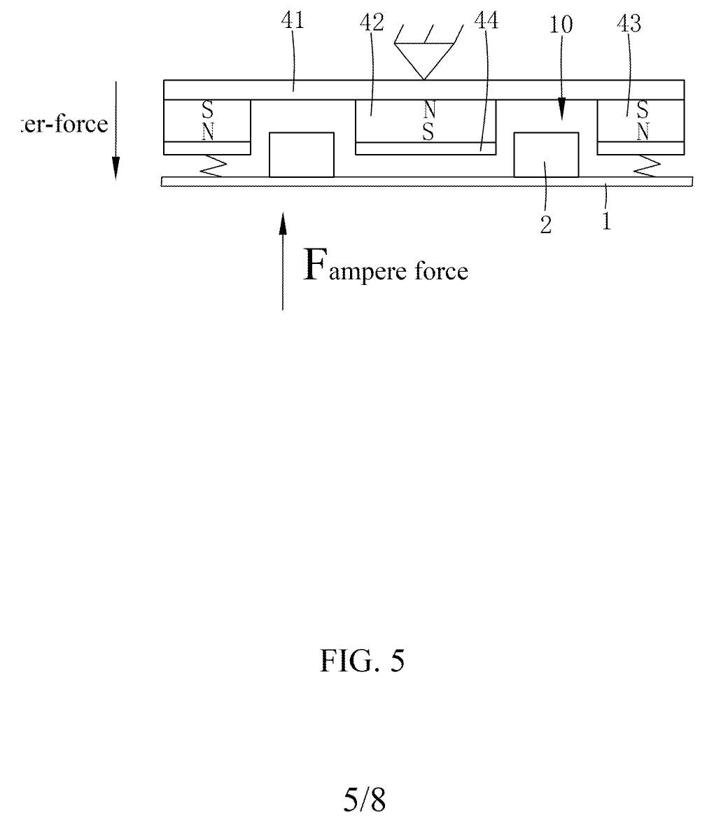

As shown in FIG. 4, if the cover plate 1 is used as a fixed component, the cover plate 1 and the coil winding 2 serve as a stator of the vibration motor 100, and correspondingly, the magnet assembly 4 serves as a rotor of the vibration motor 100, and the stator is configured to drive the rotor to vibrate. As shown in FIG. 5, if the magnet assembly 4 is used as a fixed component, the magnet assembly 4 serves as a stator of the vibration motor 100, and the cover plate 1 and the coil winding 2 serve as a rotor of the vibration motor 100.

The cover plate 1 is a non-magnetically conductive cover plate 1, the elastic member 5 is a magnetically conductive elastic member or a non-magnetically conductive elastic member, the lower clamping plate 41 is a highly magnetically conductive lower clamping plate 41, and the pole core 44 is a highly magnetically conductive pole core 44.

The cover plate 1 includes a main body portion 11, a bent portion 12 formed by bending and extending an edge of the main body 11 toward a side of the magnet assembly 4, a fixing portion 13 formed by protruding and extending an edge of the main body portion 11 outward, a through hole 14 extending through a central region of the main body portion 11, and an elongated extending hole 15 extending through the main body portion 11, the bent portion 12 and the fixing portion 13, and the extending hole 15 is in communication with the through hole 14.

The vibration motor 100 further includes a flexible circuit board 3 fixed to a side of the fixing portion 13 close to the magnet assembly 4. The coil winding 2 is arranged around the through hole 14 and fixed to a side of the main body portion 11 close to the magnet assembly 4, and two ends of the coil winding 2 extend from the extending hole 15 to the flexible circuit board 3 and form a fixed electrical connection with the flexible circuit board 3.

The magnet assembly 4 includes a lower clamping plate 41 arranged opposite to and spaced apart from the cover plate 1, a main magnet 42 stacked and fixed to a side of the lower clamping plate 41 close to the cover plate 1, an auxiliary magnet 43 arranged around the main magnet 42 and spaced apart from the main magnet 42 to form a magnetic gap 10, and the auxiliary magnet 43 is stacked and fixed to the lower clamping plate 41.

The magnet assembly 4 further includes a pole core 44 stacked and fixed to a side of the main magnet 42 close to the cover plate 1. Such design can further enhance the magnetic field strength of the magnet assembly 4.

In this embodiment, the lower clamping plate 41, the main magnet 42 and the pole core 44 are all circular, and the auxiliary magnet 43 is annular. The elastic member 5, the lower clamping plate 41, the main magnet 42, the auxiliary magnet 43 and the pole core 44 are coaxially arranged. Correspondingly, the coil winding 2 is a circular coil, and the coil winding 2 and the lower clamping plate 41 are also coaxially arranged. The coil winding 2 and the magnet assembly 4 are in a circular layout.

The elastic member 5 includes a first fixed arm 51 fixed to a side of the bent portion 12 close to the magnet assembly 4, a second fixed arm 52 fixed to a side of the auxiliary magnet 43 close to the cover plate 1, and an elastic arm 53 connecting the first fixed arm 51 with the second fixed arm 52. The elastic member 5 forms a single circular plane spring structure. In this embodiment, three elastic arm 53 at equal intervals are provided. Alternatively, according to the actual demand, the elastic member 5 can also be an elastic structure such as a double-arc plane elastic sheet, a double-rectangular plane elastic sheet, a single-circular three-dimensional spring, etc.

The pole core 44 is fixed to the main magnet 42 by bonding, the spring is fixed to the auxiliary magnet 43 by bonding, and the auxiliary magnet 43 is fixed to the lower clamp plate 41 by bonding.

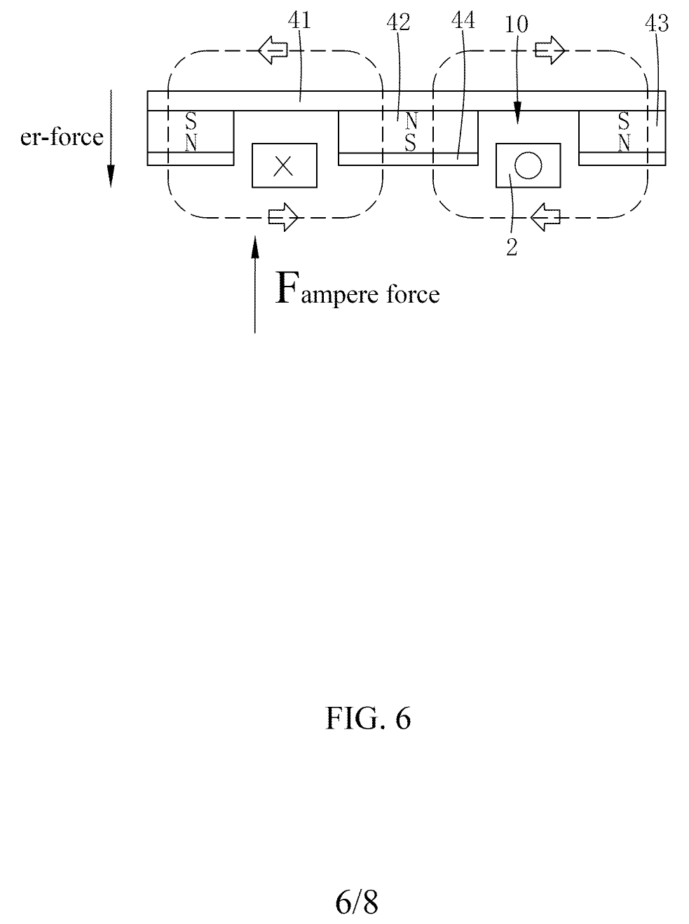

As shown in FIGS. 4 to 6, the rotor is subjected to a reverse ampere force with a direction from the magnet assembly 4 to the cover plate 1. When a reverse current is applied to the coil winding 2, a stress direction of the rotor is from the cover plate 1 to the magnet assembly 4. When a periodic current is applied to the coil winding 2, the stator generates a periodic electromagnetic resultant force on the rotor, and the resultant force is used as an excitation source to drive the vibration motor 100, composed of the stator, the rotor and the elastic member 5, to vibrate.

Compared with the related technology, the vibration motor 100 in this embodiment can form a direct-drive ultra-thin motor by arranging the cover plate 1, the coil winding 2 fixed to the cover plate 1, the magnet assembly 4 with the magnetic gap 10 and arranged opposite to and spaced apart from the cover plate 1, and the elastic member 5 elastically connecting the magnet assembly 4 to the cover plate 1. In addition, the vibration motor 100 has the advantages of fast response, strong vibration sensation, simple structure, convenient assembly, reduced production requirements and production costs, and is suitable for small-volume and low-cost devices.

### SECOND EMBODIMENT

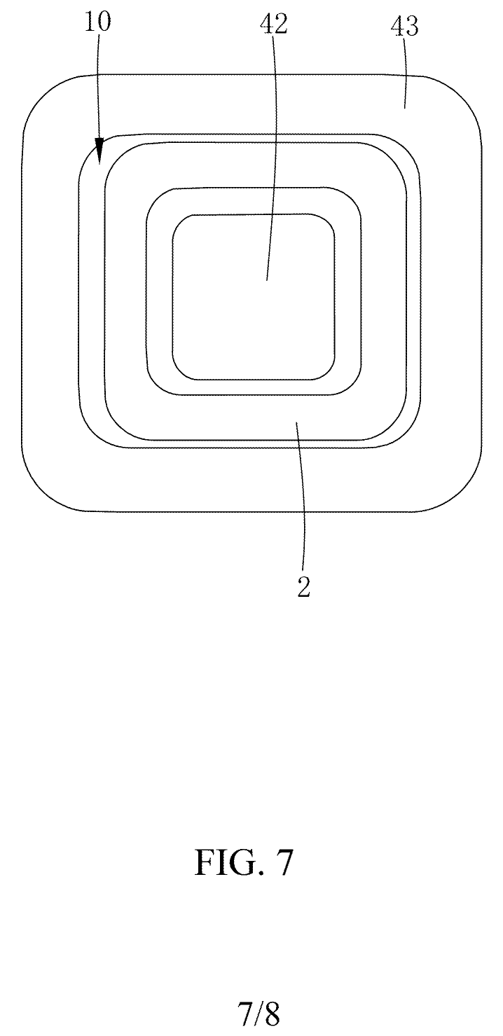

The difference between this embodiment and the above first embodiment is that, as shown in FIG. 7, the lower clamping plate 41, the main magnet 42, and the pole core 44 are all rectangular, and the auxiliary magnet 43 is rectangular annular. Correspondingly, the coil winding 2 is a rectangular annular coil. Both the coil winding 2 and the magnet assembly 4 are in a rectangular layout.

### THIRD EMBODIMENT

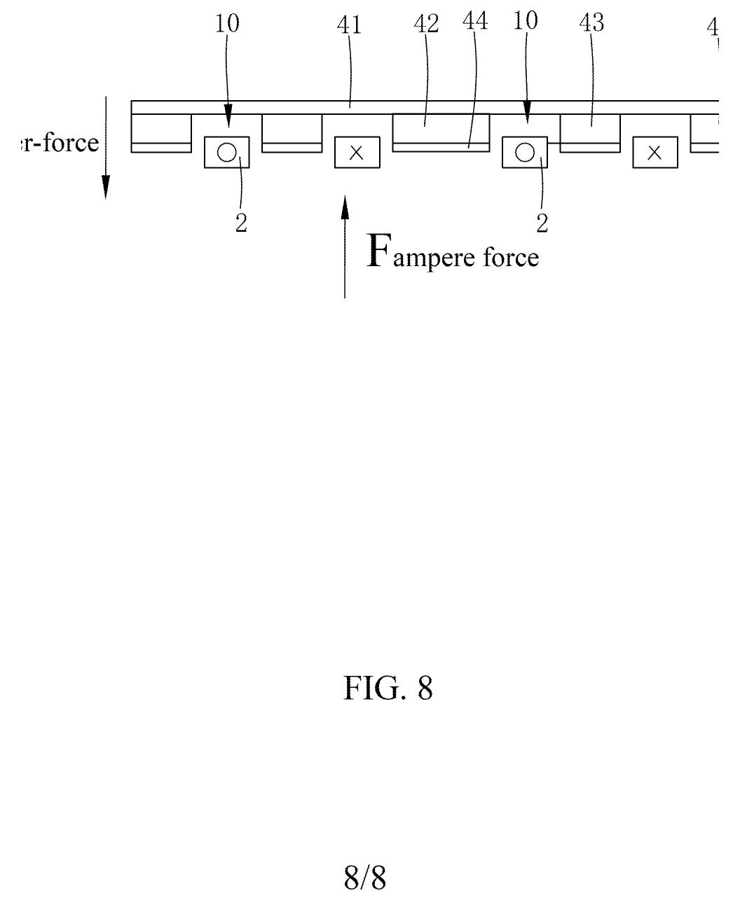

The difference between this embodiment and the above first embodiment is that, as shown in FIG. 8, the magnet assembly 4 includes a lower clamping plate 41 arranged opposite to and spaced apart from the cover plate 1, a main magnet steel 42 stacked and fixed to a side of the lower clamping plate 41 close to the cover plate 1, an auxiliary magnet 43 arranged around the main magnet and 42 and spaced apart from the main magnet 42, and a first auxiliary magnet 45 arranged around the auxiliary magnet 43 and spaced apart from the auxiliary magnet 43. Both the auxiliary magnet 43 and the first auxiliary magnet 45 are stacked and fixed to the lower clamping plate 41. The auxiliary magnet 43 and the main magnet 42 are spaced apart to form a first magnetic gap 10, and the first auxiliary magnet 45 and the auxiliary magnet 43 are spaced apart to form a second magnetic gap 10. Two coil windings 2 are respectively inserted into two magnetic gaps 10. Correspondingly, two coil windings 2 are provided, and each coil winding 2 is inserted and suspended in a magnetic gap 10. The magnet assembly 4 and the coil windings 2 form a magnetic circuit with three magnets and two coil windings.

According to actual demand, the magnet assembly 4 has a plurality of magnetic gaps 10 distributed from inside to outside. The number of coil windings 2 is the same as the number of the magnetic gaps 10, and each coil winding 2 is inserted and suspended in one of the magnetic gaps 10. That is, the magnet assembly 4 and the coil windings 2 may also form a magnetic circuit structure with four magnets and three coil windings, five magnets and four coil windings, etc.

### FOURTH EMBODIMENT

An electronic device is provided in this embodiment, which includes the vibration motor 100 according to any one of the above first embodiment to the third embodiment. The electronic device may be a laptop touchscreen, an automobile touchscreen, a tablet touchscreen, or a touchscreen of other related devices.

Since the electronic device in this embodiment includes the vibration motor 100 according to any one of the above first embodiment to the third embodiment, it can also achieve the technical effects achieved by the vibration motor 100 according to any one of the above first embodiment to the third embodiment, which is not repeated herein.

The above are only the embodiments of the present disclosure. It should be pointed out that for those skilled in the art, improvements can be made without departing from the inventive concept of the present disclosure, but these all fall within the protection scope of the present disclosure.

What is claimed is:

1. A vibration motor, comprising a cover plate, a coil winding fixed to a side of the cover plate, a magnet assembly with a magnetic gap and arranged opposite to and spaced apart from the cover plate, and an elastic member elastically connecting the magnet assembly to the cover plate, wherein the coil winding is inserted and suspended in the magnetic gap;
the cover plate and the coil winding serve as one of a rotor and a stator of the vibration motor, the magnet assembly serves as the other of the rotor and the stator of the vibration motor, and the stator is configured to drive the rotor to vibrate.

2. The vibration motor according to claim 1, wherein the magnet assembly includes a lower clamping plate arranged opposite to and spaced apart from the cover plate, a main magnet stacked and fixed to a side of the lower clamping plate close to the cover plate, an auxiliary magnet arranged around the main magnet and spaced apart from the main magnet to form the magnetic gap, and the auxiliary magnet is stacked and fixed to the lower clamping plate.

3. The vibration motor according to claim 2, wherein the magnet assembly further includes a pole core stacked and fixed to a side of the main magnet close to the cover plate.

4. The vibration motor according to claim 3, wherein the elastic member, the lower clamping plate, the main magnet, the auxiliary magnet and the pole core are coaxially arranged.

5. The vibration motor according to claim 1, wherein the cover plate includes a main body portion, a bent portion formed by bending and extending an edge of the main body portion toward a side of the magnet assembly, a fixing portion formed by protruding and extending an edge of the main body portion outward, a through hole extending through a central region of the main body portion, and an elongated extending hole sequentially extending through the main body portion, the bent portion, and the fixing portion, and the extending hole is in communication with the through hole;
the vibration motor further includes a flexible circuit board fixed to a side of the fixing portion close to the magnet assembly, the coil winding is arranged around the through hole and fixed to a side of the main body portion close to the magnet assembly, and two ends of the coil winding extend from the extending hole to the flexible circuit board and form a fixed electrical connection with the flexible circuit board.

6. The vibration motor according to claim 5, wherein the elastic member includes a first fixed arm fixed to a side of the bent portion close to the magnet assembly, a second fixed arm fixed to a side of the magnet assembly close to the cover plate, and an elastic arm connecting the first fixed arm with the second fixed arm.

7. The vibration motor according to claim 2, wherein the coil winding is annular, the main magnet is circular, and the auxiliary magnet is annular.

8. The vibration motor according to claim 2, wherein the coil winding is rectangular annular, the main magnet is rectangular, and the auxiliary magnet is rectangular annular.

9. The vibration motor according to claim 1, wherein the magnet assembly has at least two magnetic gaps distributed from inside to outside, a number of coil windings is the same as a number of the at least two magnetic gaps, and each respective coil winding of the coil windings is inserted and suspended in a respective magnetic gap of the at least two magnetic gaps.

10. The vibration motor according to claim 9, wherein the magnet assembly includes a lower clamping plate arranged opposite to and spaced apart from the cover plate, a main magnet stacked and fixed to a side of the lower clamping plate close to the cover plate, an auxiliary magnet arranged around the main magnet and spaced apart from the main magnet, and a first auxiliary magnet arranged around the auxiliary magnet and spaced apart from the auxiliary magnet, wherein the auxiliary magnet and the first auxiliary magnet are stacked and fixed to the lower clamping plate, the auxiliary magnet and the main magnet are spaced apart to form a first magnetic gap, the first auxiliary magnet and the auxiliary magnet are spaced apart to form a second magnetic gap, and two coil windings are respectively inserted into the two magnetic gaps.
